(19) United States
(12) Patent Application Publication
(10) Pub. No.: US 2008/0143488 A1
(43) Pub. Date: Jun. 19, 2008

(54) RADIO FREQUENCY IDENTIFICATION DEVICE

(76) Inventors: Masaaki Yamamoto, Kokubunji (JP); Takanori Yamazoe, Hadano (JP); Toshiyuki Kuwana, Yokohama (JP); Kazuki Watanabe, Hino (JP)

Correspondence Address: MILES & STOCKBRIDGE PC, 1751 PINNACLE DRIVE, SUITE 500, MCLEAN, VA, 22102-3833, US

(21) Appl. No.: 11/845,072

(22) Filed: Aug. 26, 2007

(30) Foreign Application Priority Data
Dec. 15, 2006 (JP) 2006-338447

(51) Int. Cl. H04B 7/00

(52) U.S. Cl. 340/10.51

(57) ABSTRACT

An Radio Frequency Identification Device (RFID) for receiving commands transmitted from a reader/writer of a RFID system to which the RFID belongs, having a demodulation circuit comprising a variable LPF, a binarization circuit connected to the variable LPF, a transmission rate detection circuit for detecting the transmission rate of a received command from an output signal of the binarization circuit, and a control circuit for setting the bandwidth corresponding to the maximum transmission rate of the received command as the reception bandwidth of the variable LPF in the initial state, and changing the reception bandwidth of the variable LPF according to the detected transmission rate of the received command.

### CLAIM OF PRIORITY

The present application claims priority from Japanese application serial No. 2006-338447, filed on Dec. 15, 2006, the content of which is hereby incorporated by reference into this application.

### BACKGROUND OF INVENTION

(1) Field of the Invention

The present invention relates to a high frequency identification device called a Radio Frequency Identification (RFID) device and, more specifically, to an RFID device which can alleviate the influence of interference due to signals transmitted by other RFID systems at the time of receiving a radio signal transmitted from a reader/writer.

(2) Description of Related Art

Generally, as shown in FIG. 1, an RFID system is comprised of radio equipment 10 called a reader/writer and a plurality of RFID devices (henceforth called RFIDs for simplicity) 30. The RFID 30 is composed of an IC chip equipped with an antenna. The RFID 30 is attached to each article 20, as shown in FIG. 1 and stores the identification information of the article 20.

The data read/write operations on the RFID 30 are performed in response to a modulated radio wave indicative of a command 40 transmitted from the reader/writer 10. Each RFID 30 demodulates the command 40 received, and transmits the data (identification information) stored in a memory in accordance with the command. Hereinafter, the data transmitted from each RFID 30 is called a “Response” 50.

FIG. 2 shows the format of the command 40 transmitted from the reader/writer 10.

The command 40 is comprised of a preamble (or frame sync) 41 and a data field 42 for indicating the contents of the command. The preamble 41 includes a bit pattern in which “1” and “0” alternate regularly. Each RFID 30 detects the transmission rate of the command during a period of receiving the preamble 41, and receives the contents of the data field 42 at the detected transmission rate.

Depending on an RFID system, the reader/writer 10 has to perform radio communication with a plurality of RFIDs 30 efficiently in a short time. For example, according to the protocol of ISO 18000-6C which is the International Standard of the UHF-band RFID, a reader/writer 10 transmits, as shown in FIG. 3, Command A 40-1 in a predetermined period T and repeats transmissions of Command B 40-2, 40-3, . . . with a fixed time interval following Command A.

Here, the transmission period T of Command A is defined as an “inventory round” and the transmission interval of the commands (Command A and Command B) within the inventory round T is defined as a “time slot.” Namely, the reader/writer 10 in conformity with ISO 18000-6C divides one inventory round T into a plurality of time slots, and transmits Command A or Command B for each time slot.

By transmitting periodically Command A indicating the number N of time slots, the reader/writer 10 instructs each RFID 30 to store the inventory round T and the number N of time slots. Upon receiving Command A, each RFID 30 selects at random a time slot to be used by itself and transmits a response in reply to the command received at the chosen time slot, in each inventory round T.

In the example shown in FIG. 3, RFID (#2) transmits Response 50-1 in reply to Command A 40-1, RFID (#1) transmits Response 50-2 in reply to Command B 40-2, and RFID (#3) transmits Response 50-3 in reply to Command B 40-3. In FIG. 3, each RFID 30 is depicted as if a single Response 50 is transmitted immediately in response to Command A or Command B, for simplicity. In practice, however, the RFID 30 transmits a pseudo random number called RN16 in reply to Command A or Command B, and the reader/writer 10 transmits an ACK command containing the same RN16 received. Finally the RFID 30 transmits identification information called EPC as Response 50.

According to this method, the reader/writer 10 can communicate with a plurality of RFIDs efficiently in a short time, by setting the inventory round T in the optimal length according to the number of RFIDs 30 to be communicate with the reader/writer 10. Further, by specifying the identifier (group ID) of the RFID system in each command, the reader/writer 10 can instruct only RFIDs each having the same group ID and belonging to a specific RFID system to reply a response.

The frequency band of the carrier available to the RFID system is defined by the international standard. In ISO 18000-6C mentioned above, the carrier-frequency band is limited to 860 MHz-960 MHz, and it is specified that the detailed arrangement about the carrier-frequency band should be determined in accordance with regulation of each country. For the carrier-frequency band of the high-output UHF-band RFID in Japan, a frequency band 952 MHz-954 MHz is assigned and a bandwidth per channel is 200 kHz.

For example, it is assumed a case where RFID system #A transmits a command through a channel with a carrier frequency of 953 MHz, while another RFID system #B transmits a command through the adjacent channel with a carrier frequency of 953.2 MHz. In this case, if the transmission rate of command in the RFID system #A is 40 kbps, the occupied bandwidth of each command transmitted by amplitude modulation is about 80 kHz.

When the RFID system #B is operating near the RFID system #A, the command (amplitude-modulated signal) S40 transmitted from the reader/writer of the RFID system #A and the 200-kHz interference wave S60 due to beat interference arrive at the RFID 30, as shown in FIG. 4. In this case, if the RFID 30 has no receiving filter suitable for eliminating the interference wave S60, the interference wave S60 may cause bit errors in the received command.

As a prior art for reducing the influence of the interference wave mentioned above, for example, US Patent Application Publication No. 2005/0237162-A1 proposes an RFID having one or a plurality of receiving filters. This RFID detects a command transmission rate in the state where a reception bandwidth is set to minimum, and readjusts the reception bandwidth to an optimum bandwidth corresponding to the detected command transmission rate.

Further, Japanese Patent Application Laid-Open Publication No. 2003-298674 proposes a multi-rate receiving apparatus with a variable communication bandwidth and a variable transmission rate. This multi-rate receiving apparatus is provided with a transmission rate detector, a plurality of low pass filters (LPFs) different in cut-off frequency, and an LPF changeover switch so that one of LPFs having the optimal characteristics is selected according to the transmission rate of received signal.

### SUMMARY OF THE INVENTION

In the US Patent Application Publication No. 2005/0237162, the transmission rate of received command is detected in the state where the reception bandwidth is set minimum. Therefore, if the occupied bandwidth of received command is wider than the reception bandwidth of the RFID, since the high-frequency components of the received signal are eliminated, there is possibility of failing in detecting the transmission rate and disabling adjustment of the reception bandwidth of the RFID.

For example, it is assumed that when the reader/writer 10 transmits a command through a channel having a carrier frequency of 953 MHz, another nearby RFID system is operating, using the adjacent channel having a carrier frequency of 953.2 MHz. Following description will be made in the case where the reader/writer 10 has three kinds of transmission rates (40 kbps, 80 kbps, and 160 kbps) as a command transmission rate, and the RFID 30 is waiting for a command to receive with the minimum reception bandwidth BW30 corresponding to the minimum transmission rate of 40 kbps.

When the reader/writer 10 transmits the command 40 at the minimum transmission rate of 40 kbps, the occupied bandwidth of the amplitude-modulated signal S40 is about 80 kHz. In this case, since the occupied bandwidth of the command is within the reception bandwidth BW30 of the RFID as shown in FIG. 5A, the RFID 30 can eliminate the 200-kHz interference wave S60 generated by beat interference and detect the transmission rate from the preamble of the received command 40 correctly. In this case, the RFID 30 can adjust the reception bandwidth to the optimal bandwidth according to the detected transmission rate (in this example, the bandwidth adjustment is not necessary).

However, when the reader/writer 10 transmits the command 40 at the transmission rate of 80 kbps, the occupied bandwidth of the amplitude-modulated signal S40 is about 160 kHz and exceeds the reception bandwidth BW30 of the RFID, as shown in FIG. 5B. In this case, since the RFID 30 cannot receive signal components having the frequency of 80 kHz or higher, the RFID 30 has possibility of failing in detection of the transmission rate and in readjustment of the reception bandwidth.

Further, when the reader/writer 10 transmits the command 40 at the transmission rate of 160 kbps, the occupied bandwidth of the amplitude-modulated signal S40 is about 320 kHz, greatly exceeding the reception bandwidth BW30 of the RFID, as shown in FIG. 5C. Also in this case, the RFID 30 may fail in detecting the transmission rate and have possibility of failing in readjustment of the reception bandwidth.

An object of the present invention is to provide an RFID capable of receiving correctly a command transmitted from a reader/writer of an RFID system to which the RFID belongs, in a circumstance where a plurality of RFID systems are operating.

In order to accomplish the above object, an RFID device according to the present invention includes, as a part of a receiving circuit, a demodulation circuit comprising: a detector connected to an antenna; a low pass filter (LPF) unit connected to the detector, the LPF unit being composed of a variable LPF controllable its reception bandwidth; a binarization circuit connected to the LPF unit; a transmission rate detection circuit for detecting a transmission rate of a received command based on an output signal from the binarization circuit; and a control circuit operable to control the reception bandwidth of the variable LPF according to the transmission rate of received command detected by the transmission rate detection circuit. The control circuit sets the reception bandwidth of the variable LPF, as an initial state, to a bandwidth corresponding to the maximum transmission rate of the received command and subsequently changes the reception bandwidth of the variable LPF to a bandwidth corresponding to the transmission rate of received command detected by the transmission rate detection circuit.

In an RFID according to another embodiment of the present invention, the LPF unit is composed of a plurality of LPFs different in reception bandwidth and each individually provided with a binarization circuit, and the demodulation circuit is comprised of a transmission rate detection circuit for detecting a transmission rate of a received command based on an output signal from the binarization circuit connected to one of the plurality of LPFs, which has a reception bandwidth corresponding to the maximum transmission rate of the received command, and a control circuit operable to select one of the plurality of LPFs according to the transmission rate of received command detected by the transmission rate detection circuit, whereby an output signal from the binarization circuit connected to the selected LPF is outputted as an output signal of the demodulation circuit.

In an RFID according to further another embodiment of the present invention, the LPF unit is composed of a plurality of LPFs different in reception bandwidth and each individually provided with a binarization circuit, and the demodulation circuit is comprised of a transmission rate detection circuit for detecting a transmission rate of a received command based on output signals from the binarization circuits; and a control circuit operable to select one of the plurality of LPFs according to the transmission rate of received command detected by the transmission rate detection circuit, whereby an output signal from the binarization circuit connected to the selected LPF is outputted as an output signal of the demodulation circuit.

According to the present invention, each RFID can detect the transmission rate of received command correctly, since the reception bandwidth of the LPF can cover the occupied bandwidth of received command when detecting the received command transmission rate. Further, since the reception bandwidth of the LPF is optimized in accordance with the received command transmission rate, the RFID according to the present invention can receive commands, reducing the influence due to an interference wave.

### BRIEF DESCRIPTION OF THE DRAWINGS

Embodiments of the present invention will be described in detail based on the following figures, wherein:

FIG. 1 is a block diagram illustrating a general structure of an RFID system;

FIG. 2 is a diagram illustrating a frame format of a command which a reader/writer 10 transmits in the RFID system;

FIG. 3 is a time chart illustrating relationship between commands transmitted from the reader/writer 10 and responses replied from RFIDs 30 in the RFID system;

FIG. 4 is an explanatory diagram illustrating relationship between an occupied bandwidth of command and an interference wave;

FIGS. 5A-5C are explanatory diagrams illustrating relationships between a reception bandwidth in a receiving circuit and an occupied bandwidth of received command;

FIG. 6 is a block diagram illustrating an RFID 30 to which the present invention is applied;

FIG. 7 is a block diagram illustrating a demodulation circuit 31 provided in the RFID 30 according to a first embodiment of the present invention;

FIGS. 8A-8C are explanatory diagrams illustrating relationships between a reception bandwidth and an occupied bandwidth of received command in a demodulation circuit according to the first embodiment of the present invention;

FIG. 9 is a chart illustrating improvement effect of CIR in the first embodiment of the present invention;

FIG. 10 is a block diagram illustrating a demodulation circuit 31 provided in the RFID 30 according to a second embodiment of the present invention;

FIG. 11 is an exemplified schematic diagram illustrating a concrete circuitry of LPF 311 shown in FIG. 10;

FIG. 12 is a block diagram illustrating a demodulation circuit 31 provided in the RFID 30 according to a third embodiment of the present invention;

FIGS. 13A-13C are explanatory diagrams illustrating relationships between a reception bandwidth and an occupied bandwidth of received command in a demodulation circuit, according to the second and the third embodiment of the present invention; and

FIG. 14 is a time chart for the case where optimization of reception bandwidth is performed for each period T.

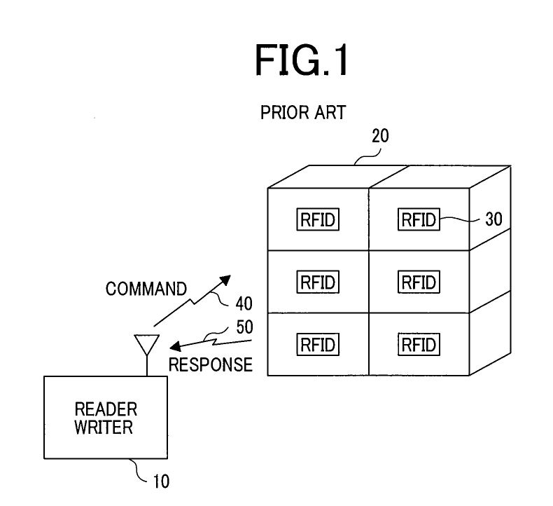

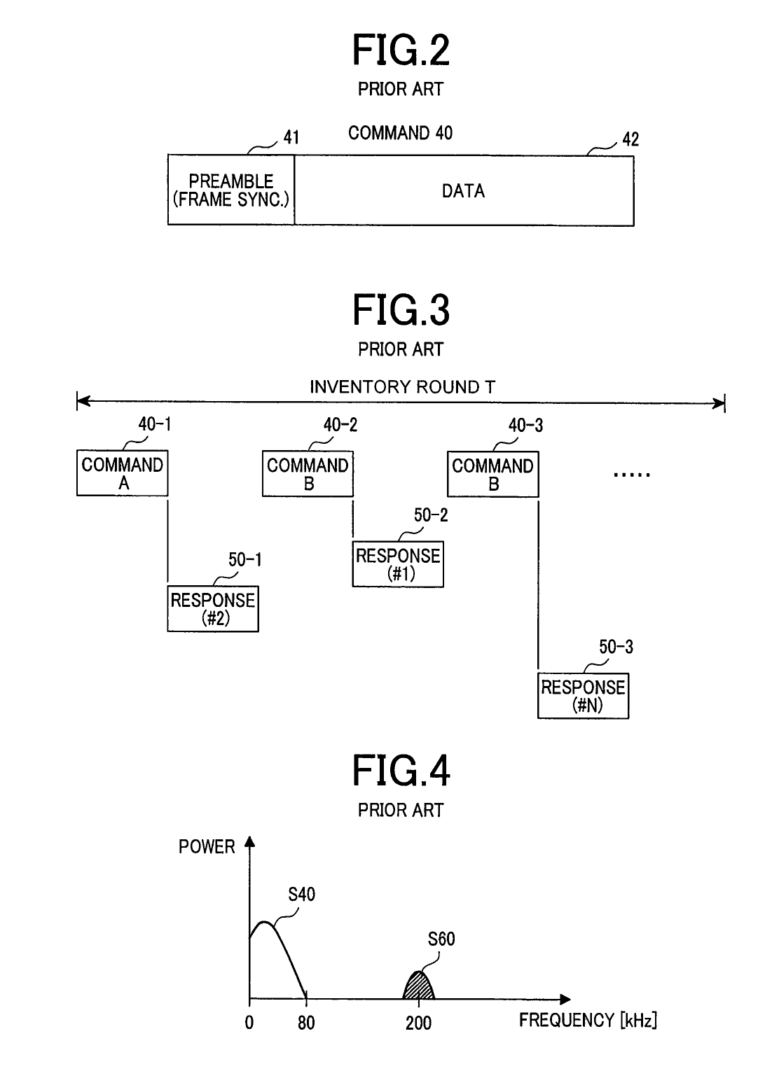

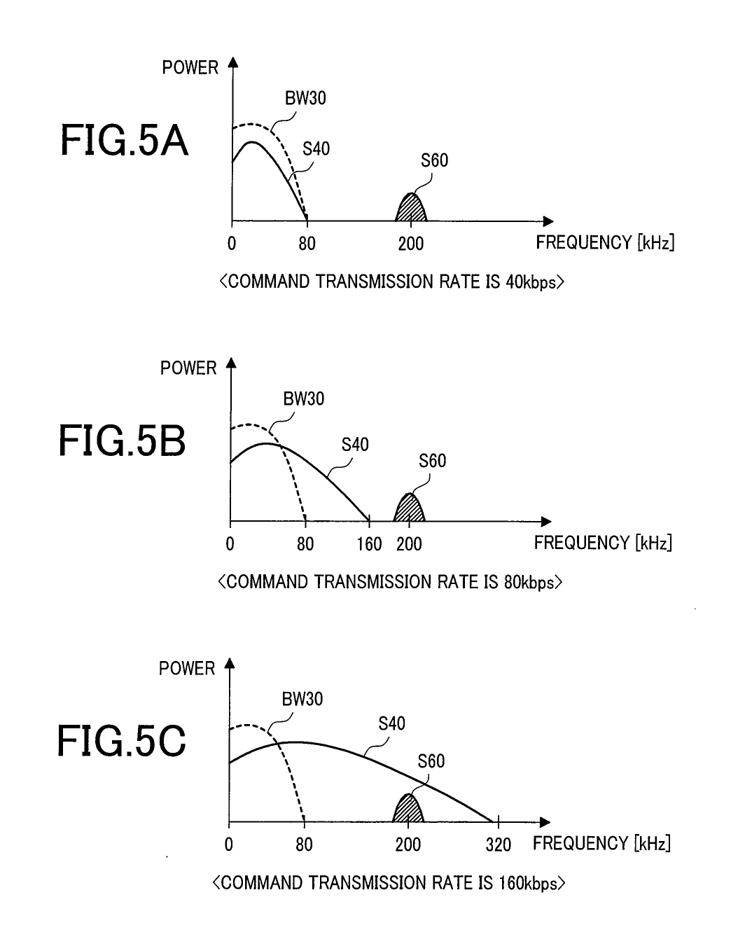

### DETAILED DESCRIPTION OF PREFERRED EMBODIMENTS

Hereinafter, embodiments of the present invention will be explained in detail by referring to the accompanying drawings.

### Embodiment 1

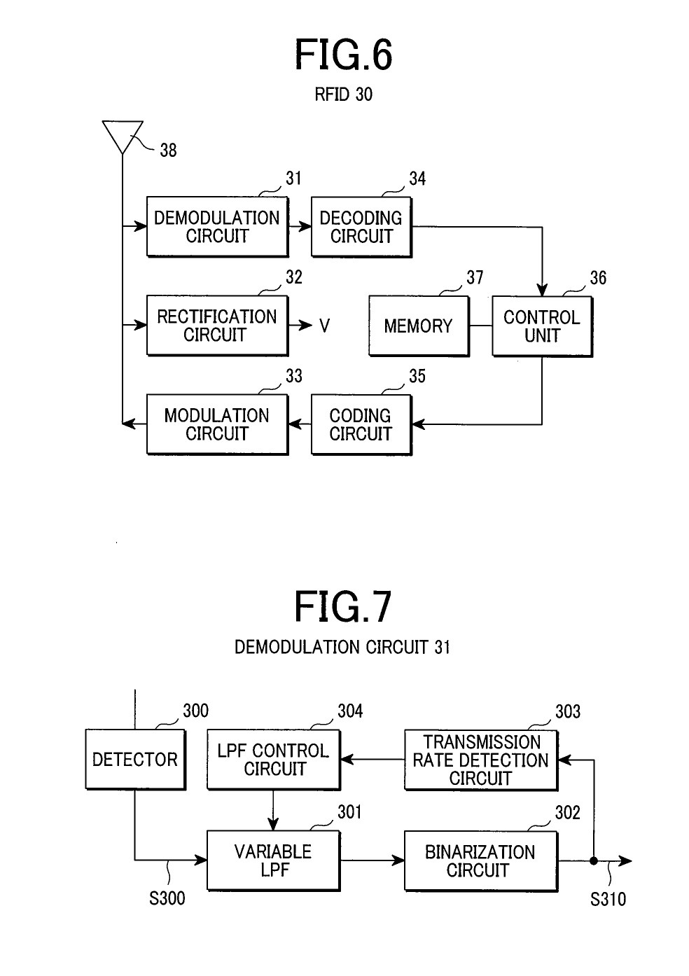

FIG. 6 is a block diagram illustrating an RFID 30 according to an embodiment of the present invention.

The RFID 30 is comprised of a demodulation circuit 31, a rectification circuit 32 and a modulation circuit 33, each of which is connected to an antenna 38. The RFID 30 is further comprised of a decoding circuit 34 connected to the demodulation circuit 31, a coding circuit 35 connected to the modulation circuit 33, a control unit 36 connected to the decoding circuit 34 and the coding circuit 35, and a nonvolatile memory 37 connected to the control unit 36. These elements 31-37 are built into an IC chip.

The rectification circuit 32 serves as a generation source of supply voltage necessary for operating the RFID 30. In the memory 37, such information as a system identifier and an RFID identifier is stored. A command received by the antenna 38 is converted into a binary signal through the demodulation circuit 31 as will be described later, decoded into digital data (command) by the decoding circuit 34, and inputted into the control unit 36.

When the received command is Command A, the control unit 36 stores the number of time slots indicated by Command A, selects at random a target time slot to be used in replying a response, and waits for reception of a command in the target time slot. Upon receiving the command in the target time slot, the control unit 36 transmits a response 50. However, if the time slot of Command A was selected as the target time slot, the control unit 36 transmits the response 50 immediately in response to the Command A.

The response 50 (RN16 and EPC in practice) includes the RFID identifier and other information read out from the memory 37. The response 50 is coded by the coding circuit 35, amplitude-modulated by the modulation circuit 33, and transmitted as a radio signal from the antenna 38.

FIG. 7 shows a diagram of the demodulation circuit 31 according to the first embodiment.

The demodulation circuit 31 includes a detector 300 for eliminating a carrier-frequency component from the signal received by the antenna 38, a low pass filter (LPF) unit 301 for eliminating interference-wave components from an output signal S300 of the detector 300, and a binarization circuit 302 connected to the LPF unit 301. The output signal S310 of the binarization circuit 302 is outputted as the output signal of the demodulation circuit 31.

In the first embodiment, the LPF unit 301 is composed of a variable LPF having a variable reception bandwidth. The reception bandwidth of the variable LPF 301 is adapted to the command transmission rate by a transmission rate detection circuit 303 and an LPF control circuit 304.

The feature of the first embodiment resides in that, at the time of receiving each command, the LPF control circuit 304 starts bandwidth control of the variable LPF 301 after setting the reception bandwidth of the variable LPF 301 to an initial state in which the reception bandwidth is adjusted to the occupied bandwidth at the maximum command transmission rate.

During the receiving period of the preamble (or frame sync) 41 of Command A, the transmission rate detection circuit 303 detects the command transmission rate from the output of the binarization circuit 302, and outputs the detection result to the LPF control circuit 304. The LPF control circuit 304 controls the variable LPF 301 so that the reception bandwidth of the variable LPF 301 becomes equal to a predetermined occupied bandwidth corresponding to the command transmission rate detected by the transmission rate detection circuit 303.

Although the demodulation circuit 31 uses the variable LPF for the purpose to eliminating or reducing the influence of an interference wave in the present embodiment, radio equipment is possible to use a band-pass filter for the same purpose. However, the reception bandwidth of the band-pass filter is fixed, and the center frequency of the band-pass filter is changed in accordance with the frequency band to be received. Therefore, the band-pass filter has such a problem that, if the center frequency of the filter is raised in order to receive a signal of high frequency band, for example, it becomes impossible to receive signal components of a low frequency band which is out of the reception band. This kind of problem does not arise in the LPF.

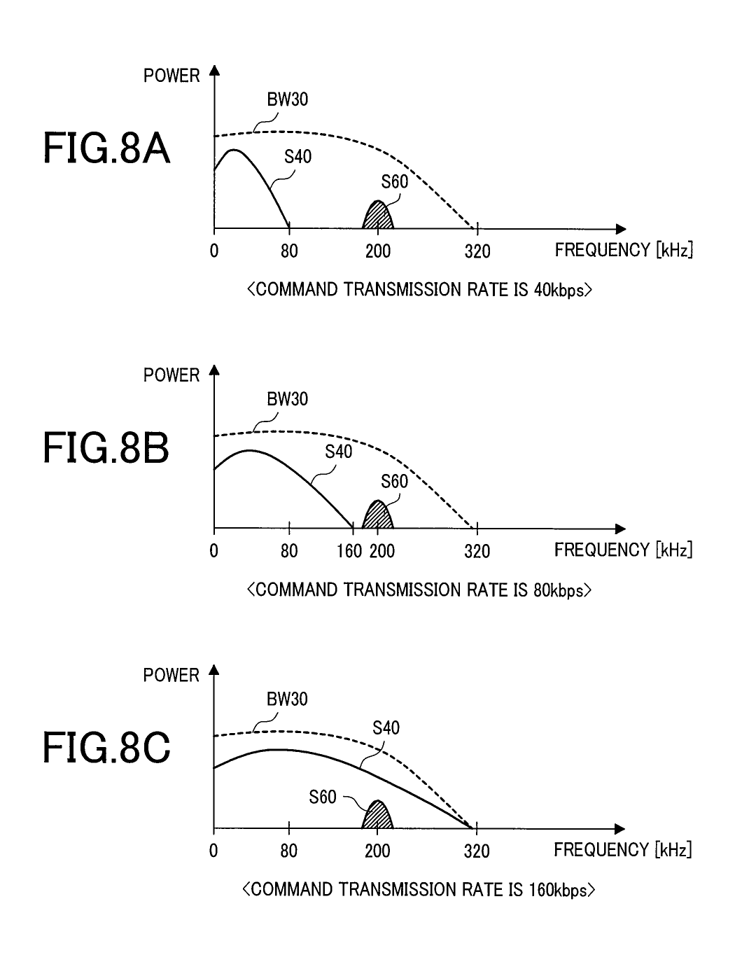

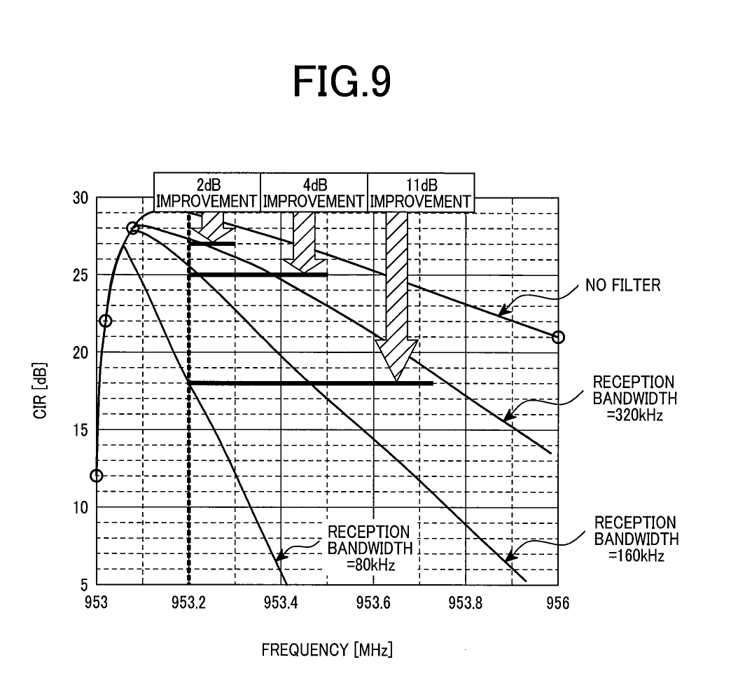

Next, the operation of the demodulation circuit 31 shown in FIG. 7 will be explained with reference to FIGS. 8A-8C and FIG. 9.

It is supposed here such a case where, for example, when the reader/writer 10 transmits a command as an amplitude-modulated signal through a channel with a carrier frequency of 953 MHz, another RFID system operates using the adjacent channel with a carrier frequency of 953.2 MHz. In the demodulation circuit 31 according to the present embodiment, the transmission rate of received command is detected in the state where the initial reception bandwidth of the variable LPF 301 is set to the occupied bandwidth corresponding to the command transmission at the maximum rate.

When the reader/writer 10 has two stages of command transmission rates, 40 kbps and 80 kbps, the reception bandwidth of the variable LPF 301 is initialized to an occupied bandwidth of 160 kHz corresponding to the maximum transmission rate of 80 kbps. If the reader/writer 10 has three stages of command transmission rates, 40 kbps, 80 kbps, and 160 kbps, the initial reception bandwidth of the variable LPF 301 is set to an occupied bandwidth of 320 kHz corresponding to the maximum transmission rate of 160 kbps. The reception bandwidth of the LPF 301 is switched to an optimum bandwidth adapted to the command transmission rate when the transmission rate of the received command is clarified.

When the actual transmission rate of the command 40 transmitted from the reader/writer 10 is at the lowest 40 kbps, the occupied bandwidth of the command is about 80 kHz. In this case, if the initial reception bandwidth was set to 160 kHz, the variable LPF 301 can get through all frequency components of the received command, while eliminating the 200-kHz interference wave generated by beat interference. Therefore, the received command transmission rate can be detected satisfactory.

However, if the initial reception bandwidth BW30 of the variable LPF 301 was set to 320 kHz, as shown in FIG. 8A, the initial reception bandwidth BW30 covers not only the occupied bandwidth of the command 40 (amplitude-modulated signal S40) but also the 200-kHz interference wave S60 generated by the beat interference. Therefore, there is a possibility of occurring an error in detection of the command transmission rate, depending on the situation of other RFID systems located nearby.

When the command transmission rate is detected correctly by the transmission rate detection circuit 303, the reception bandwidth BW30 of the variable LPF 301 is readjusted to the bandwidth adapted to the actual command transmission rate of 40 kbps by the LPF control circuit 304. Since the readjusted reception bandwidth BW30 covers the occupied bandwidth 80 kHz of the command of 40 kbps, eliminating the interference wave S60, the command portion in the data field which follows the preamble can be received without being influenced by the interference wave S60.

FIG. 9 shows the relationship between a CIR (vertical axis) and carrier frequencies acting as interference waves (horizontal axis). The CIR stands for a carrier-to-interference ratio and means a signal power-to-interference power ratio for the RFID after adjusting the reception bandwidth thereof.

In the case of no receiving filter, the CIR at which the RFID 30 can respond is 29 dB. When the reception bandwidth of the RFID 30 is readjusted to 80 kHz, the CIR improves by about 11 dB compared with the case of no receiving filter, and the influence of the interference wave is reduced.

In the case where the actual transmission rate of the command 40 is 80 kbps, the occupied bandwidth of the command 40 is about 160 kHz. If the initial reception bandwidth was set to 160 kHz, the variable LPF 301 can get through all frequency components of the received command, while eliminating the 200-kHz interference wave generated by beat interference. Therefore, the received command transmission rate can be detected satisfactory. If the initial reception bandwidth was set to 320 kHz, the initial reception bandwidth BW30 of the variable LPF 301 covers not only the occupied bandwidth of the command 40 at 80 kbps (amplitude-modulated signal S40) but also the 200-kHz interference wave S60 generated by the beat interference, as shown in FIG. 8B. Therefore, there is a possibility of occurring an error in detection of the command transmission rate.

When the command transmission rate is correctly detected by the transmission rate detection circuit 303, the LPF control circuit 304 can readjust the reception bandwidth BW30 of the variable LPF 301 to the bandwidth adapted to the actual command transmission rates of 80 kbps. The readjusted reception bandwidth BW30 covers the occupied bandwidth 160 kHz of the command, eliminating the interference wave S60. When the reception bandwidth of the RFID 30 was readjusted to 160 kHz, as shown in FIG. 9, the CIR improves by about 4 dB compared with the case of no receiving filter and the influence of the interference wave is reduced.

In the case where the actual transmission rate of the command 40 is 160 kbps, the occupied bandwidth of the command 40 is about 320 kHz. Also in this case, as shown in FIG. 8C, since the reception bandwidth BW30 of the variable LPF 301 covers the occupied bandwidth of the command 40 (amplitude-modulated signal S40) and the 200-kHz interference wave S60 generated by the beat interference, there is a possibility of occurring an error in detection of the command transmission rate. However, if the command transmission rate was correctly detected by the transmission rate detection circuit 303, the LPF control circuit 304 can readjust the reception bandwidth BW30 of the variable LPF 301 to the bandwidth adapted to the actual command transmission rates of 160 kbps. In this case, the readjusted reception bandwidth BW30 includes both the occupied bandwidth 320 kHz of the command and the interference wave S60. However, it turns out, as shown in FIG. 9, that the CIR at which the RFID 30 can respond to the command improves by about 2 dB compared with the case of no receiving filter and the influence of the interference wave is still reduced.

According to the first embodiment mentioned above, since the transmission rate of command is detected in the state where the reception bandwidth of the variable LPF 301 is initialized to the occupied bandwidth for the command transmission at the maximum rate, it becomes possible, regardless of the actual transmission rate of the command, to detect the command transmission rate using all the frequency components of the preamble (or the frame sync). Although there is a possibility of occurring an error in detecting the transmission rate, depending on the maximum transmission rate of the command and the state of the interference wave, the reception bandwidth can be optimized according to the command transmission rate if the command transmission rate was detected correctly, thereby reducing the detrimental influence of the interference wave.

The above-mentioned initialization and optimization of the reception bandwidth for the variable LPF may be carried out for each command. However, it is also preferable to perform the initialization and optimization of the reception bandwidth for the variable LPF only at the time of receiving the command A, which is transmitted from the reader/writer 10 periodically in every inventory round T, so as to fix the reception bandwidth of the variable LPF during the receiving period of Command B, as will be described later.

### Embodiment 2

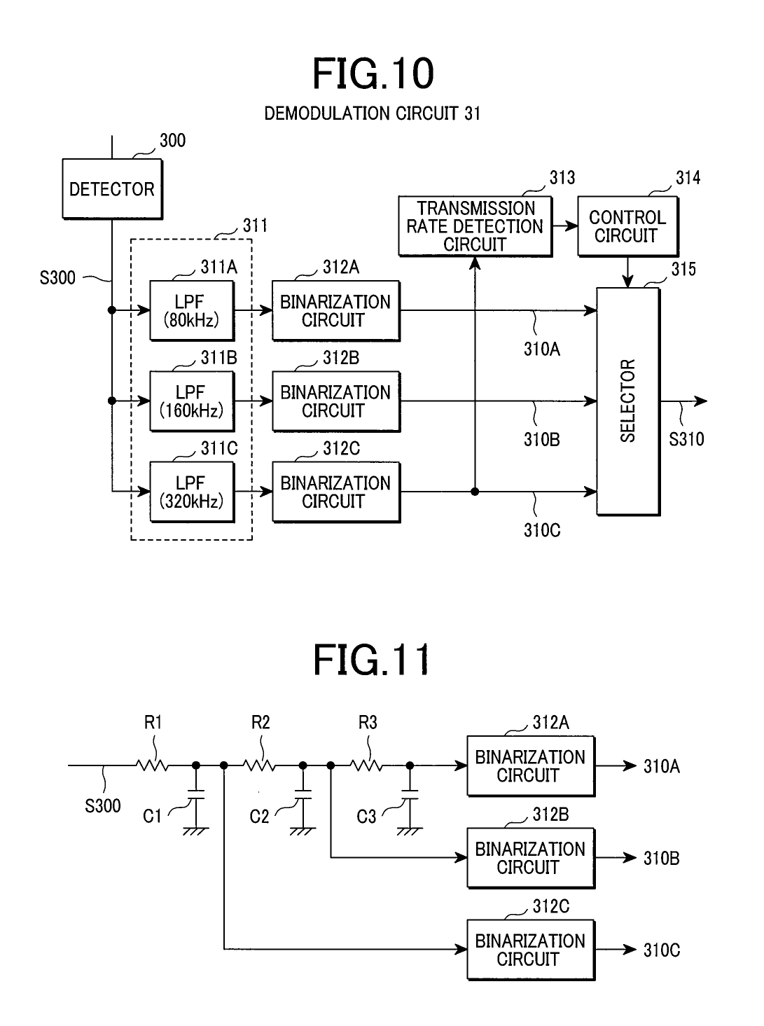

FIG. 10 shows a block diagram of a demodulation circuit applied to the RFID according to a second embodiment of the present invention.

The demodulation circuit 31 of the second embodiment is provided with a plurality of LPFs different in the reception bandwidth to each other, which are connected to the output circuit of the detector 300. Here, it is assumed that the reader/writer 10 transmits each command as an amplitude-modulated signal at a transmission rate of 40 kbps, 80 kbps, or 160 kbps. In this case, the output signal S300 of the detector 300 is supplied to a first LPF 311A with an 80-kHz reception bandwidth, a second LPF 311B with a 160-kHz reception bandwidth, and a third LPF 311C with a 320-kHz reception bandwidth. The output signals of LPFs 311A, 311B and 311C are converted into the binary signals 310A, 310B, and 310C through binarization circuits 312A, 312B, and 312C, respectively.

In the present embodiment, the binary signals 310A, 310B, and 310C are inputted into a selector 315. The binary signal 310C outputted from the binarization circuit 312C connected to the third LPF with the greatest reception bandwidth is inputted to the transmission rate detection circuit 313. The control circuit 314 controls the selector 315 so that the binary signal of LPF adapted to the command transmission rate detected by the transmission rate detection circuit 313 is selected as the output S310 of the demodulation circuit.

In similar to the transmission rate detection circuit 303 of the first embodiment, the transmission rate detection circuit 313 detects the command transmission rate from the binary signal 310C during the receiving period of the preamble (or frame sync) of Command A, and outputs the detection result to the LPF control circuit 314. By judging the output of the transmission rate detection circuit 313, the control circuit 314 select one of LPFs, which has a reception bandwidth corresponding to the transmission rate, and controls the selector 315 so that the binary signal from the selected LFP is outputted as the output S310 of the demodulation circuit.

FIG. 11 shows one example of the concrete circuitry of the LPF unit 311 shown by a dotted rectangle in FIG. 10.

The LPF unit 311 is comprised of a first, second, and third resistor element R1, R2, and R3 which are connected in series, and a first, second, and third capacitance element C1, C2, and C3 which are connected in parallel between the output end of each resistor element and the ground potential. The first LPF 311A is formed by R1-R3 and C1-C3, the second LPF 311B is formed by R1, R2, C1, and C2, and the third LPF 311C is formed by R1 and C1. The output signals from these LPFs are supplied to the binarization circuits 312A, 312B, and 312C in parallel.

When the transmission rate of the command 40 is the lowest 40 kbps, the control circuit 314 selects the LPF 311A having the reception bandwidth 30A corresponding to the 40-kbps command transmission rate, and controls the selector 315 so that the output of the binarization circuit 312A connected to the LPF 311A is selected as the output signal S310 of the demodulation circuit.

When the transmission rate of the command 40 is 80 kbps, the control circuit 314 selects the LPF 311B having the reception bandwidth 30B corresponding to the 80-kbps command transmission rate, and controls the selector 315 so that the output of the binarization circuit 312B connected to the LPF 311B is selected as the output signal S310 of the demodulation circuit.

If another RFID system operates using the adjacent channel when the reader/writer 10 transmits the command 40 at a transmission rate of 160 kbps, a 200-kHz interference wave is generated due to beat interference. If there is little influence of the interference wave S60, the transmission rate detection circuit 313 can detect the 160-kbps command transmission rate correctly, from the output of the binarization circuit 312C. In this case, the control circuit 314 selects the LPF 311C having the reception bandwidth 30C corresponding to the 160-kbps command transmission rate, and controls the selector 315 so that the output of the binarization circuit 312C connected to the LPF 311C is selected as the output signal S310 of the demodulation circuit.

Once the control circuit 314 selects an LPF and a binarization circuit corresponding to the command transmission rate, the present embodiment can provide the same improvement effect as in the first embodiment explained in FIG. 9. Further, if the occupied bandwidth of the command transmitted at the maximum transmission rate is lower than the frequency of the interference wave, for example, 160 kHz, the transmission rate detection circuit 313 can detect the command transmission rate correctly from the output of the binarization circuit corresponding to the maximum transmission rate.

### Embodiment 3

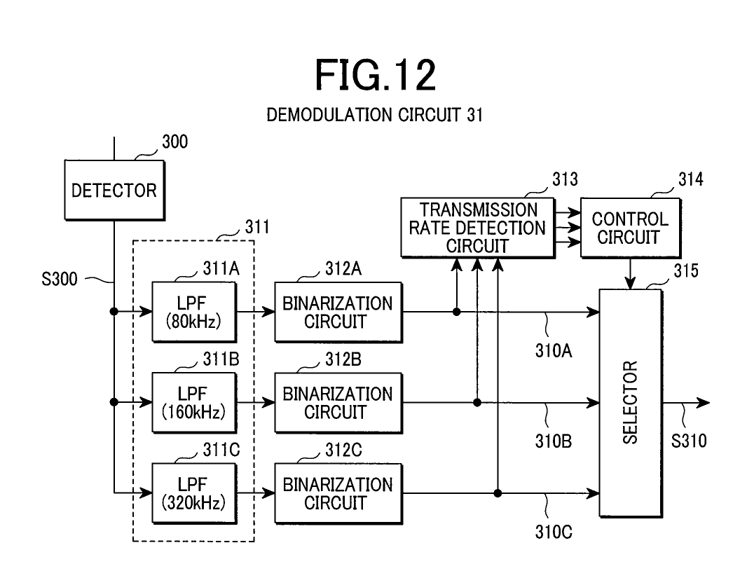

FIG. 12 shows a block diagram of a demodulation circuit applied to the RFID according to a third embodiment of the present invention.

The demodulation circuit 31 of the third embodiment includes, at the output circuit of the detector 300, a first LPF 311A, a second LPF 311B, and a third LPF 311C different in the reception bandwidth to each other, and binarization circuits 312A, 312B, and 312C, similarly to the second embodiment. Here, as in the second embodiment, it is assumed that the reader/writer 10 transmits each command as an amplitude-modulated signal at the transmission rate of 40 kbps, 80 kbps, or 160 kbps. In this case, the reception bandwidths of the first LPF 311A, the second LPF 311B, and the third LPF 311C become 80 kHz, 160 kHz, and 320 kHz, respectively.

In the present embodiment, the binary signals 310A, 310B, and 310C are inputted into the transmission rate detection circuit 313. During the receiving period of the preamble (or frame sync) of Command A, the transmission rate detection circuit 313 detects the command transmission rate from the binary signals 310A, 310B, and 310C, and outputs the detection result to the control circuit 314. By judging the output of the transmission rate detection circuit 313, the control circuit 314 selects one of LPFs, which has a reception bandwidth corresponding to the transmission rate, and controls the selector 315 so that the binary signal generated from the output of the selected LPF is selected as the output S310 of the demodulation circuit 31.

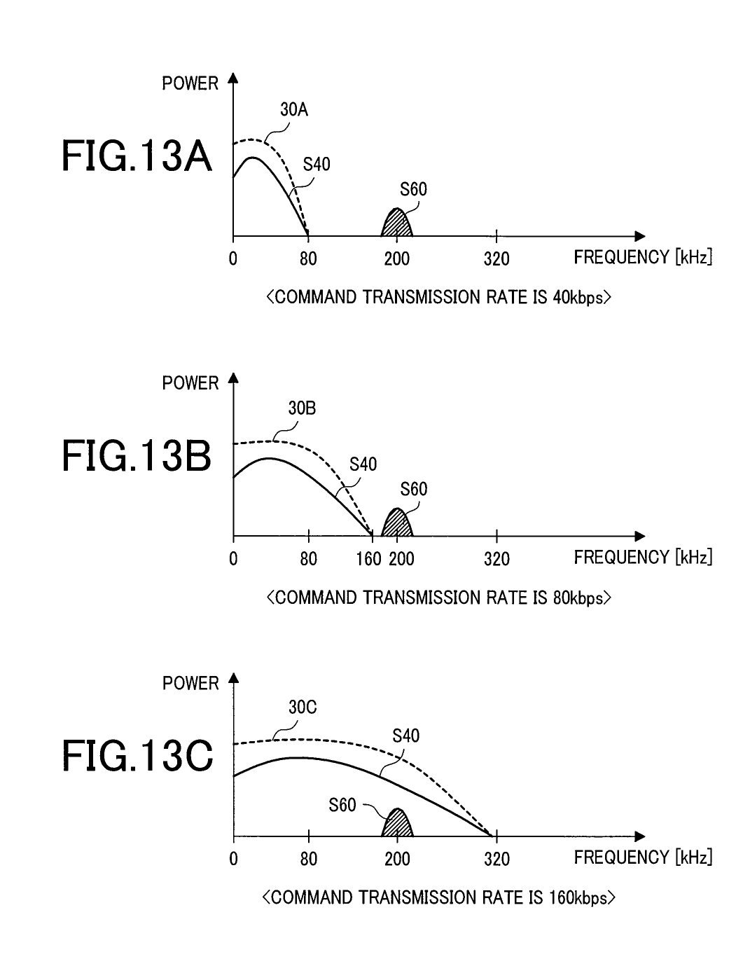

FIGS. 13A, 13B, and 13C show the relationships among the reception bandwidths 30A, 30B, and 30C of the LPFs 311A, and 311B and 311C, the interference wave S60, and the occupied bandwidth (amplitude-modulated signal S40) of the received command, respectively.

When the transmission rate of the command 40 is the lowest 40 kbps, the LPFs 311A and 311B can get through all the frequency bands of the received command and block the interference wave S60. The LPF 311C gets through both the frequency bands of the received command and the interference wave S60. However, the transmission rate detection circuit 313 can detect the 40-kbps command transmission rate correctly from the output of at least one of the binarization circuits 312A and 312B. The control circuit 314, therefore, can select the LPF 311A having the reception bandwidth 30A corresponding to the command transmission rate of 40 kbps, and control the selector 315 so that the output of the binarization circuit 312A connected to the LPF 311A is outputted as the output signal S310 of the demodulation circuit.

When the transmission rate of the command 40 is 80 kbps, the LPF 311A gets through only the low frequency components of the received command, and blocks the high frequency components of the received command and the interference wave S60. The LPF 311B can get through all frequency bands of the received command and block the interference wave S60. The LPF 311C gets through all frequency bands of the received command and the interference wave S60.

In this case, since the output signal of the LPF 311A is deteriorated in wave shape and amplitude, it becomes difficult to detect the command transmission rate correctly from the output signal of the binarization circuit 312A. However, from the binarization circuit 312B connected to the LPF 311B, a binary pulse signal with the command transmission rate is outputted. Therefore, the transmission rate detection circuit 313 can detect the 80-kbps command transmission rate correctly from at least the output of the binarization circuit 312B, and the control circuit 314 can select the LPF 311B having the reception-bandwidth 30B corresponding to the 80-kbps command transmission rate, and control the selector 315 so that the output of the binarization circuit 312B connected to the LPF 311B is outputted as the output signal S310 of the demodulation circuit.

When the transmission rate of the command 40 is 160 kbps, the LPFs 311A and 311B get through only the low frequency components of the received command, and block the high frequency components of the received command and the interference wave S60. The LPF 311C gets through all frequency bands of the received command and the interference wave S60. In this case, since the output signals of the LPFs 311A and 311B are deteriorated in wave shape and amplitude, it becomes difficult to detect the command transmission rate correctly from the output signals of the binarization circuits 312A and 312B.

However, if the influence of the interference wave S60 is not so strong, the transmission rate detection circuit 313 can detect the 160-kbps command transmission rate correctly from the output of the binarization circuit 312C. In this case, the control circuit 314 can select the LPF 311C having the reception bandwidth 30C corresponding to the 160-kbps command transmission rate, and controls the selector 315 so that the output of the binarization circuit 312C connected to the LPF 311C is outputted as the output signal S310 of the demodulation circuit.

Once the control circuit 314 selects an LPF and a binarization circuit corresponding to the command transmission rate, the present embodiment can provide the same improvement effect as in the first embodiment explained in FIG. 9. In the case of first and second embodiments, since the command transmission rate is detected by using an LPF having the reception bandwidth corresponding to the maximum transmission rate of the command detects, if the reception bandwidth is 320 kHz and the 200-kHz interference wave exists, there is a possibility of occurring an error in the detection result of the transmission rate. On the other hand, in the case of third embodiment, since the command transmission rate is detected by using a plurality of LPFs different in reception bandwidth, if the occupied band of the command is lower than the frequency of the interference wave, the command transmission rate can be detected without error, eliminating the influence of the interference wave.

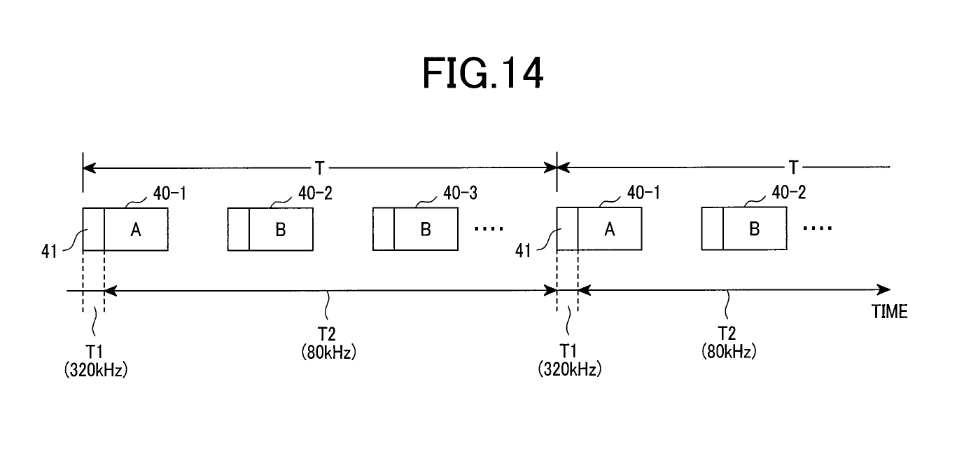

FIG. 14 is a time chart of command transmission in the case where optimization of a reception bandwidth is performed for each period T.

In each inventory round T, the reader/writer 10 transmits Command A 40-1 first. After that, the reader/writer 10 transmits Commands B 40-2, 40-3 . . . , repeatedly at a fixed time interval. Here, description will be made in the case where the transmission rate of the command is 40 kbps.

When the RFID 30 is provided with the variable LPF 301 as in the first embodiment, the LPF control circuit 304 sets the reception bandwidth of the variable LPF 301 to an initial state (320 kHz in the present example) in each inventory round T, and detects the command transmission rate during receiving period T1 of the preamble (or frame sync) 41 of Command A. Upon detecting the command transmission rate, the LPF control circuit 304 readjusts the reception bandwidth of the variable LPF 301 to the occupied bandwidth of the received command (about 80 kHz in the present example), in the middle of or at the end of the preamble (or frame sync) 41. During the remaining period of the inventory round T (i.e. period T2), the reception bandwidth of the variable LPF 301 is kept unchanged. By repeating the same procedure in each inventory round, the reception bandwidth of the variable LPF 301 can be optimized.

When the RFID 30 is provided with a plurality of LPFs different in the reception bandwidth as in the second and third embodiments, optimization of the reception bandwidth according to the time chart of FIG. 14 can be realized by the LPF control circuit 304, by selecting an LPF having the optimal reception bandwidth based on the command transmission rate detected during receiving period T1 of the preamble (or frame sync) 41 of Command A, and by keeping the LPF during the remaining period T2 of the inventory round T.

In the time chart shown in FIG. 14, the reader/writer 10 transmits a plurality of commands by repeating the inventory round T. However, the reader/writer 10 may terminate the radio communication with the RFIDs after transmitting Command A and a predetermined number of Commands B at fixed time intervals, and resume the same operation at an arbitrary time later. In this case, the demodulation circuit 31 of each RFID waits for a next Command A to arrive after executing one cycle of operations shown in FIG. 14.

What is claimed is:

1. A radio frequency identification (RFID) device operable to respond a command transmitted in wireless from a reader/writer composing a radio frequency identification (RFID) system, the RFID device including a demodulation circuit as a part of a receiving circuit, the demodulation circuit comprising:
a detector connected to an antenna;
a low pass filter (LPF) unit connected to said detector, the LPF unit being composed of a variable LPF controllable its reception bandwidth;
a binarization circuit connected to said LPF unit;
a transmission rate detection circuit for detecting a transmission rate of a received command based on an output signal from said binarization circuit; and
a control circuit operable to control the reception bandwidth of said variable LPF according to the transmission rate of received command detected by said transmission rate detection circuit,
wherein said control circuit sets the reception bandwidth of said variable LPF, as an initial state, to a bandwidth corresponding to the maximum transmission rate of the received command and subsequently changes the reception bandwidth of the variable LPF to a bandwidth corresponding to the transmission rate of received command detected by said transmission rate detection circuit.

2. The RFID device according to claim 1, wherein said control circuit repeats said initial state setting and subsequent changing of the reception bandwidth of said variable LPF for each command received from said reader/writer.

3. The RFID device according to claim 1, wherein said control circuit performs said initial state setting and subsequent changing of the reception bandwidth of said variable LPF at a time of receiving a specific command transmitted from said reader/writer at fixed intervals, and operates to receive at least one of subsequent commands from the reader/writer, keeping the reception bandwidth of the variable LPF unchanged until next specific command reception.

4. The RFID device according to claim 1, wherein said control circuit performs said initial state setting and subsequent changing of the reception bandwidth of the variable LPF at a time of receiving a specific command transmitted from said reader/writer, and operates to receive at least one of subsequent commands from the reader/writer, keeping the reception bandwidth of the variable LPF unchanged until communication with the reader/writer terminates.

5. A radio frequency identification (RFID) device operable to respond a command transmitted in wireless from a reader/writer composing a radio frequency identification (RFID) system, the RFID device including a demodulation circuit as a part of a receiving circuit, the demodulation circuit comprising:
a detector connected to an antenna;
a low pass filter (LPF) unit connected to the detector, the LPF unit being composed of a plurality of LPFs different in reception bandwidth and each individually provided with a binarization circuit;
a transmission rate detection circuit for detecting a transmission rate of a received command based on an output signal from the binarization circuit connected to one of said plurality of LPFs, which has a reception bandwidth corresponding to the maximum transmission rate of the received command; and
a control circuit operable to select one of said plurality of LPFs according to the transmission rate of received command detected by said transmission rate detection circuit, whereby an output signal from the binarization circuit connected to the selected LPF is outputted as an output signal of the demodulation circuit.

6. The RFID device according to claim 5, wherein said control circuit includes a selector connected to output lines of said binarization circuits and controls the selector so as to output an output signal of the binarization circuit connected to said selected LPF as the output signal of the demodulation circuit.

7. The RFID device according to claim 5, wherein said control circuit selects, at a time of receiving a specific command transmitted from said reader/writer at fixed intervals, one of said plurality of LPFs according to the transmission rate of specific command detected by said transmission rate detection circuit, and receives at least one of subsequent commands from the reader/writer using the selected LPF until next specific command reception.

8. The RFID device according to claim 5, wherein said control circuit selects one of said plurality of LPFs according to the transmission rate of a specific command detected by the transmission rate detection circuit, and receives at least one of subsequent commands from the reader/writer using the selected LPF until communication with the reader/writer terminates.

9. A radio frequency identification (RFID) device operable to respond a command transmitted in wireless from a reader/writer composing a radio frequency identification (RFID) system, the RFID device including a demodulation circuit as a part of a receiving circuit, the demodulation circuit comprising:
a detector connected to an antenna,
a low pass filter (LPF) unit connected to the detector, the LPF unit being composed of a plurality of LPFs different in reception bandwidth and each individually provided with a binarization circuit;
a transmission rate detection circuit for detecting a transmission rate of a received command based on output signals from said binarization circuits; and
a control circuit operable to select one of the plurality of LPFs according to the transmission rate of received command detected by said transmission rate detection circuit, whereby an output signal from the binarization circuit connected to the selected LPF is outputted as an output signal of the demodulation circuit.

10. The RFID device according to claim 9, wherein said control circuit includes a selector connected to output lines of said binarization circuits and controls the selector so as to output an output signal of the binarization circuit connected to said selected LPF as the output signal of the demodulation circuit.

11. The RFID device according to claim 9, wherein said control circuit selects, at a time of receiving a specific command transmitted from said reader/writer at fixed intervals, one of said plurality of LPFs according to the transmission rate of specific command detected by said transmission rate detection circuit, and receives at least one of subsequent commands from the reader/writer using the selected LPF until next specific command reception.

12. The RFID device according to claim 9, wherein said control circuit selects one of said plurality of LPFs according to the transmission rate of a specific command detected by the transmission rate detection circuit, and receives at least one of subsequent commands from the reader/writer using the selected LPF until communication with the reader/writer terminates.

13. The RFID device as defined in one of claim 1, wherein said transmission rate of received command is detected during receiving period of one of a preamble and a frame sync which are located at the head of the received command.

14. The RFID device as defined in one of claim 5, wherein said transmission rate of received command is detected during receiving period of one of a preamble and a frame sync which are located at the head of the received command.

15. The RFID device as defined in one of claim 9, wherein said transmission rate of received command is detected during receiving period of one of a preamble and a frame sync which are located at the head of the received command.
